(19) United States
(12) Patent Application Publication
(10) Pub. No.: US 2008/0228878 A1
(43) Pub. Date: Sep. 18, 2008

(54) Signaling Support for Grouping Data and Voice Users to Share the Radio Resources in Wireless Systems

(76) Inventors: Tao Wu, Carlsbad, CA (US); Jianmin Lu, San Diego, CA (US); Zhigang Rong, San Diego, CA (US); Anthony C.K. Soong, Plano, TX (US)

Correspondence Address: Slater & Matsil, L.L.P., 17950 Preston Road, Suite 1000, Dallas, TX, 75252, US

(21) Appl. No.: 12/013,065

(22) Filed: Jan. 11, 2008

Related U.S. Application Data
(60) Provisional application No. 60/895,072, filed on Mar. 15, 2007.

(51) Int. Cl. G06F 15/16

(52) U.S. Cl. 709/205

(57) ABSTRACT

Sharing radio resources between multiple types of users is disclosed that form user groups including first type users and second type users. A plurality of resource blocks is assigned to the user group after which, a group setup message is transmitted to each user in the user group. This group setup message includes group parameters and identification of the resource blocks. A group grant message is also issued to each user in the user group, which provides group information allowing the resource blocks to be shared between the first and second user types.

This application claims the benefit of U.S. Provisional Application No. 60/895,072, filed on Mar. 3, 2007, entitled “SIGNALING SUPPORT FOR GROUPING DATA AND VOICE USERS TO SHARE THE RADIO RESOURCES IN WIRELESS SYSTEMS,” which application is hereby incorporated herein by reference.

### CROSS-REFERENCE TO RELATED APPLICATIONS

This application is related to: U.S. Application Ser. No. 60/824,284, filed on Aug. 31, 2006, entitled “METHOD AND APPARATUS FOR GROUPING USERS TO SHARE THE SAME TIME-FREQUENCY RESOURCES IN A WIRELESS COMMUNICATIONS SYSTEM”, by Jianmin Lu, Tao Wu, Yunsong Yang, and Quanzhong Gao; and U.S. Application Ser. No. 60/791,700, filed on Apr. 13, 2006, entitled “METHOD AND APPARATUS FOR SHARING RADIO RESOURCES IN AN OFDM-BASED COMMUNICATION SYSTEM”, by Yunsong Yang, Jianmin Lu, and Anthony C. K. Soong; and U.S. Application Ser. No. 60/793,961, filed on Apr. 20, 2006, entitled “METHOD AND APPARATUS FOR SHARING RADIO RESOURCES USING MULTI-USER PACKET FORMAT AND SINGLE USER PACKET FORMAT IN AN OFDMA-BASED COMMUNICATION SYSTEM”, by Anthony C. K. Soong, Yunsong Yang, and Jianmin Lu; and U.S. Application Ser. No. 60/824,283, filed on Aug. 31, 2006, entitled “METHOD AND APPARATUS FOR SHARING RADIO RESOURCES IN A WIRELESS COMMUNICATIONS SYSTEM”, by Yunsong Yang, Anthony C. K. Soong, and Jianmin Lu; U.S. Application Ser. No. 60/829,526, filed on Aug. 31, 2006, entitled “METHOD AND APPARATUS FOR INDICATING THE RESOURCE THAT ARE VALID FOR SHARING IN AN OFDMA-BASED COMMUNICATION SYSTEM” by Anthony C. K. Soong, Jianmin Lu and Zhigang Rong; all of which are incorporated herein by reference as if reproduced in their entirety.

### TECHNICAL FIELD

The present invention relates, in general, to wireless communications systems, and, more particularly, to multiplexing data user transmissions with voice user transmissions over the same time-frequency resource.

### BACKGROUND

While packet data traffic and applications have been rapidly increasing, the quality of voice transmission is still a fundamental aspect of designing wireless communication systems. Efficient management of coexisting voice and data users is important to network performance. For example, in a wideband code division multiple access (WCDMA) system, transmissions of packet data and voice over internet protocol (VoIP) traffic between a base station (BS) and user equipment (UE) are typically scheduled by the BS.

Voice traffic is typically discontinuous in nature and is generally composed of large inactive periods. It is often desirable to group a certain number of voice users together and assign them a set of shared time-frequency resources. A statistical multiplexing gain is, thereafter, achieved among the group members because not all of the users assigned to the group will need to use the shared resources at any one time (i.e., there does not have to be the same amount of resources assigned to each of the users in the groups; the group can efficiently operate with less than that total amount of resources allocated). When the BS has determined a discontinuous transmission (DTX) state for a particular user in a particular time period, it can assign that user's time-frequency resources to another user. The statistical multiplexing gain may also be achieved through early terminated hybrid automatic repeat request (HARQ) transmissions. Once a user acknowledges its VoIP packet, the time-frequency resources will usually become available to other group members based on the implemented scheduling algorithm.

A unique identifier, GroupID, is typically assigned when a group is established. As the BS assigns a UE to the group, it associates the UE's media access control (MAC) index (MACID) to the GroupID using a Group Setup Message managed by upper layer signaling. The BS will also typically assign resources to the group using a group grant message (group grant). Each group grant is generally identified by the GroupID and explicitly indicates the start of group resources. The bitmap identifying VoIP users in the group grant typically has one field with one or more bits for each VoIP user to indicate if that VoIP user is activated or not. Any activated voice user is generally able to locate its assigned resource blocks (RBs) by looking to the group grant.

A BS usually assigns a large number of RBs (e.g., 25 or the like) in a group grant for one or more groups to share. For each group, the start of the assigned group resources is generally designated so that it is the RB next to the end of previous group resource allocation. Any remaining RBs in the group grant may then be dynamically scheduled to data users with a data grant message.

Once a group of users is established, the group grant may also be used by the users to determine their exact resources within the set of shared time-frequency resources. The group grant is typically used for the first subpacket and subsequent retransmissions of that first subpacket. Each UE is generally assigned a unique ordering index within the group and a fixed interlace offset within a superframe for its first subpacket transmission. This ordering and interlace offset are used to align the time between successive first transmissions to the vocoder frame duration (approximately 20 msec).

When the VoIP user bitmap is configured to have a single bit, it generally indicates if the user is activated or not. This single bit method will typically be used with a default modulation coding scheme (MCS). When the VoIP user bitmap is configured to have more bits, it is often able to indicate not only the on/off activation state, but also the MCS options and number of RBs.

The UEs are also assigned an acknowledgement (ACK) position based on their position assignment in the first bitmap transmission. For example, with ‘N’ representing the total number of UEs in the specific sector, the first N/2 UEs in the first bitmap transmission will be assigned to transmit their ACK in the first ACK position, while the second N/2 UEs in the first bitmap transmission will be assigned to transmit their ACK in the second ACK position. Alternatively, an even/odd structure may be used, whereby UEs with an odd position assignment in the first bitmap transmission will be assigned to transmit their ACK in the first ACK position, while UEs with an even position assignment in the first bitmap transmission will be assigned to transmit their ACK in the second ACK position.

According to the statistical characteristics of voice traffic, the assigned size of the set of time-frequency resources and the acceptable VoIP latency and capacity are usually traded off carefully. In order to ensure a desired performance level, there are typically left-over resources in the group most of the time. With coexistence of both voice and data users, it is beneficial to include certain type of data users (for example, best effort traffic) in the group together with the VoIP users and have the data users take the left over resource for packet data transmissions. However, even dynamically assigning a particular set of resources to the data users, the unused RBs available to the voice users create a built-in inefficiency to this set-up.

### SUMMARY OF THE INVENTION

Select ones of the various embodiments of the present invention multiplex the voice and data users, enabling them to share the same time-frequency resources to achieve an efficient utilization of the radio resource and, therefore, better performance of a wireless system. Other than dynamically scheduling data users with specific scheduling control messages, it saves the extra forward link control signaling overhead by having data users share the resource with voice users in multiple groups while maintaining higher priority for voice user transmissions.

Representative embodiments of the present invention provide methods for assigning communication resources to share between different types of users. The methods form user groups that include one or more first users of a first type and one or more second users of a second type. A plurality of resource blocks is assigned to the user group after which, a group setup message is transmitted to each user in the user group, where the message includes group parameters and identification of the resource blocks. A group grant message is also issued to each user in the user group. The group grant message provides group information allowing the resource blocks to be shared between the one or more first users of the first type.

Additional representative embodiments of the present invention provide methods for a data user to obtain communication resources in a wireless communication network. In these additional embodiments, the data user receives a group setup message at the data user identifying at least (1) a group of users sharing a set of communication resources, (2) the set of communication resources, and (3) a unique scrambling code for the data user. The data user further receives an active user signal identifying the data user as an active share data user, and receives a group grant message at the active share data user. The group grant message uses bitmap signaling for identifying a first boundary of a subset of the set of communication resources allocated to the active share data user and identifying a modulation and coding scheme (MCS) for the active share data user. The active share data user then uses the subset of the set of communication resources to perform data communication.

Additional representative embodiments of the present invention provide computer program products having a computer readable medium with computer program logic recorded thereon. The computer program products include code for forming a user group that includes one or more first users of a first type and one or more second users of a second type, code for assigning a plurality of resource blocks to the user group, code for transmitting a group setup message to each user in the user group, and code for issuing a group grant message to each user in the user group. The group setup message includes group parameters and identification of the plurality of resource blocks, while the group grant message provides group information allowing the plurality of resource blocks to be shared between the one or more first users of the first type.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1A is a block diagram illustrating an idealized representation of a typical group grant message;

FIG. 1B is a block diagram illustrating an idealized representation of a typical group resource allocation map;

FIG. 2A is a block diagram illustrating a group grant configured according to one embodiment of the present invention;

FIG. 2B is a block diagram illustrating a group grant configured according to one embodiment of the present invention;

FIG. 2C is a block diagram illustrating extended a group grant configured according to one embodiment of the present invention;

FIG. 3A is a block diagram illustrating a resource allocation scheme according to Mode 1 for multiplexing multiple voice and data users in a network configured according to one embodiment of the present invention;

FIG. 3B is a block diagram illustrating a resource allocation scheme according to Mode 2 for multiplexing multiple voice and data users in a network configured according to one embodiment of the present invention;

FIG. 3C is a block diagram illustrating a resource allocation scheme according to Mode 3 for multiplexing multiple voice and data users in a network configured according to one embodiment of the present invention;

FIG. 3D is a block diagram illustrating a resource allocation scheme according to Mode 4 for multiplexing multiple voice and data users in a network configured according to one embodiment of the present invention;

FIG. 3E is a block diagram illustrating a resource allocation scheme according to Mode 5 for multiplexing multiple voice and data users over the same time-frequency resource in a network configured according to one embodiment of the present invention;

FIG. 4 is a block diagram illustrating a sector of a network configured according to one embodiment of the present invention;

FIG. 5A is a flowchart illustrating example steps executed to implement one embodiment of the present invention;

FIG. 5B is a flowchart illustrating example steps executed to implement another embodiment of the present invention; and

FIG. 6 is a block diagram illustrating a computer system adapted to use embodiments of the present invention.

### DETAILED DESCRIPTION OF ILLUSTRATIVE EMBODIMENTS

The present invention provides a novel method to have the voice and data users share the same time-frequency resource, which results in a more efficient utilization of wireless radio resource and thus improves the performance of a wireless system. It is understood, however, that the following disclosure provides many different embodiments, or examples, for implementing different features of the invention. Specific examples of components, signals, messages, protocols, and arrangements are described below to simplify the present disclosure. These are, of course, merely examples and are not intended to limit the invention from that described in the claims. Well known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry described herein are omitted, as such control circuits are within the skills of persons of ordinary skill in the relevant art.

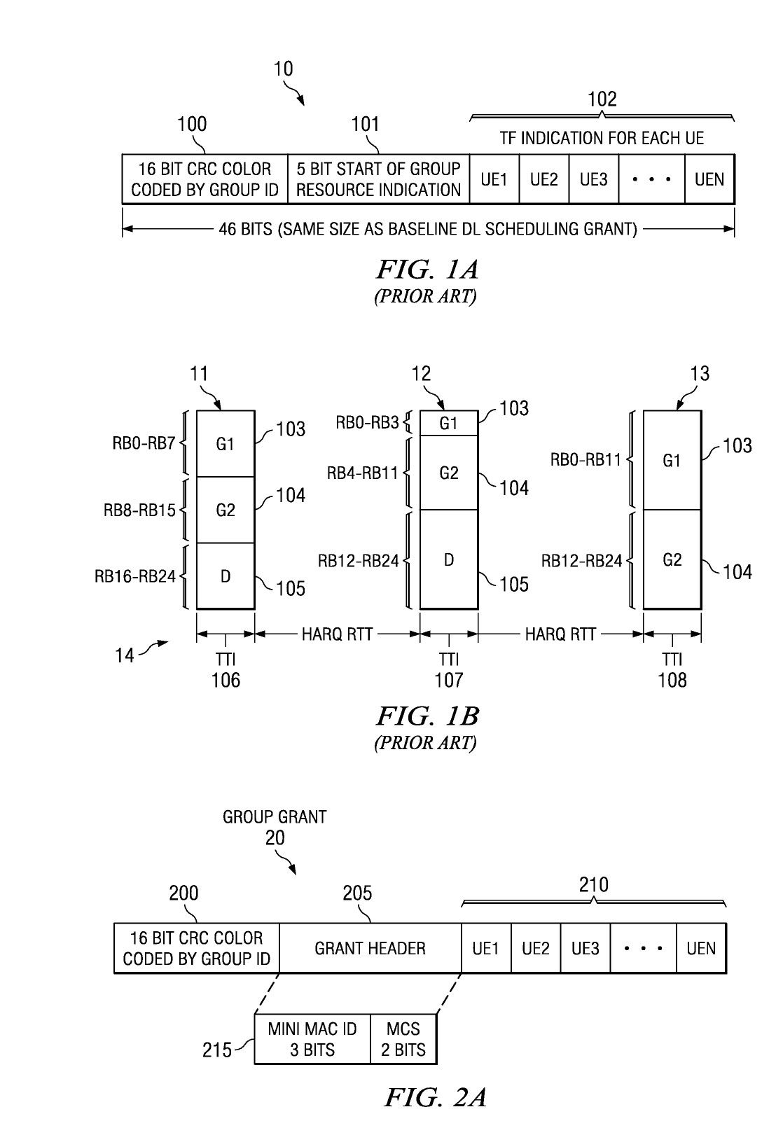

FIG. 1A is a block diagram illustrating a typical idealized example of group grant 10. Group grant 10 is 46 bits in length, which is the same size as the baseline downlink (DL) scheduling grant. The message includes 16-bit CRC color-coded by GroupID 100, 5-bit group resource address 101, and transmission format (TF) indicators 102 providing the specific address of the assigned resource for each UE in the group, UE1-UE‘N’, where ‘N’ represents the total number of UE in the group. TF indicators 102 generally indicate the VoIP users being served with a single bit for each user or access terminal (AT). It may also indicate the size of assigned resources and/or the packet format using multiple bits for each AT. Group resource address 101 provides the starting address of the allocated group resources.

In this example, N=25 VoIP users that are assigned to the group. TF indicators 102 for UE1 through UE‘N’ indicate the VoIP users being served with a single bit for each UE, or indicate the size of assigned resource and/or packet format with multiple bits for each UE

FIG. 1B is a block diagram illustrating a typical idealized example of group resource allocations 11-13 of 25 RBs. Each of group resource allocations 11-13 represent allocations depending on the user make-up of the particular sector at a given time, transmission timeline 14. In a situation where there are a few data users and a typical number of voice users assigned to groups 1 and 2 (G1 103 & G2 104), group resource allocation 11 is provided by the serving BS (not shown). RB0-RB7 are assigned to G1 103, RB8-RB15 are assigned to G2 104, and RB16-RB24 are reserved for dynamic allocation to data users, D 105. Transmission timeline 14 provides that group resource allocation 11 is transmitted to UEs within the sector over first transmission time interval (TTI) 106. The remaining time after first TTI 106 is used for HARQ roundtrip transmissions (roundtrip transmission time (RTT)).

In operation according to group resource allocation 11, statistically, not all of RB0-RB7 will be used by active UE within G1 103. Therefore, unused resources will statistically exist somewhere in RB0-RB7. Similarly, there will be unused RBs in the allocation of RB8-RB15 to G2 104. Therefore, if the number of data users request resources exceeding the reserved dynamic allocation portion, RB16-RB24, such data users will be delayed access to transmission resources until such resources within RB16-RB24 become available. When unused resources exist within the allocations to G1 103 and G2 104 at the same time that data users are being delayed network access, the entire system is running inefficiently. However, the desire to maintain voice quality in current systems drives this inefficiency of the network.

In the next allocation time interval, TTI 107, the BS transmits group resource allocation 12. Within the intervening time, the number of voice users requesting network access decreased. Thus, the corresponding allocations to G1 103 and G2 104 have decreased to RB0-RB3 and RB4-RB11, respectively. As such, the amount of RBs reserved for dynamic data user allocation, D 105, is correspondingly expanded. Data users which were delayed or denied access to the network during implementation of group resource allocation 11 are now allowed to access the network through reserved RB12-RB24.

During the time of TTI 108, the number of voice users requesting network access has increased greatly. As such, the BS transmits group resource allocation 13 to the sector UEs. The entire 25 RB allocation is now divided exclusively between G1 103 and G2 104. RB0-RB11 to G1 103 and RB12-RB24 to G2 104. During this time period, while unused resources will exist within the two allocation sets, RB0-RB11 and RB12-RB24, data users will, nonetheless, have no available resources. This current methodology for allocating resources within such networks continues to perpetuate inefficient use of the network resources.

According to one aspect of the present invention, the Group Setup Message is sent by the base station to set up the grouping initially and to add users to the group. A group is defined with a set of group and user specified parameters, such as GroupID, resource location, number of VoIP users, number of data users, bitmap length, and the like. The Group Setup Message in Table 1 is sent to each VoIP user and the Group Setup Message in Table 2 is sent to each data user. As an example to minimize the overhead requirement on MCS indication, four MCS indices (Mod Coding_{—}1, 2, 3, and 4) are set in Group Setup Message for a data user based on this user's channel condition. Consequently, only 2-bits are required to explicitly indicate the MCS index for that data user. The mapping from these bits to actual MCS can be adjusted by upper layer signaling, based on long-term channel quality and/or power availability.

TABLE 1
Group Setup Message for Voice Users

| Field | Description |
|---|---|
| MAC_Index | Unique identifier of the AT |
| Group_ID | Unique identifier for the group |
| Block_Size | The fundamental block size |
| | (e.g. 1 DRCH by 1 Frame) |
| Num_Blocks | Number of blocks assigned to this group |
| First_Block | Address of the first block in the assignment |
| Ordering_Pattern | One of a few choices indicating the order in which |
| | the blocks are to be distributed |
| F_Mod_Coding | Coding and modulation for full rate frames |
| H_Mod_Coding | Coding and modulation for half rate frames |
| Q_Mod_Coding | Coding and modulation for quarter rate frames |
| E_Mod_Coding | Coding and modulation for eighth rate frames |
| Interlace_Structure | The pattern and structure of the VoIP interlace |
| Bitmap1_Length | Length of the first bitmap |
| Bitmap2_Length | Length of the second bitmap (if used) |
| Bitmap_Channel | Time frequency resources for the bitmap itself |
| AT_Index | The bitmap position assigned to the AT |
| Interlace_Offset | Offset assigned to the AT indicative of its first |
| | transmission |

TABLE 2
Group Setup Message for Data Users

| Field | Description |
|---|---|
| MAC_Index | Unique identifier of the AT |
| Group_ID | Unique identifier for the group |
| Block_Size | The fundamental block size |
| | (e.g. 1 DRCH by 1 Frame) |
| Num_Blocks | Number of blocks assigned to this group |
| First_Block | Address of the first block in the assignment |
| Ordering_Pattern | One of a few choices indicating the order |
| | in which the blocks are to be distributed |
| Mod_Coding_1 | Lowest modulation and coding scheme ‘00’ |
| Mod_Coding_2 | Third highest modulation and |
| | coding scheme ‘01’ |
| Mod_Coding_3 | Second highest modulation and |
| | coding scheme ‘10’ |
| Mod_Coding_4 | Highest modulation and coding scheme ‘11’ |
| Interlace_Structure | The pattern and structure of the VoIP interlace |
| Bitmap1_VoIP_Length | Length of the VoIP bitmap in the first bitmap |
| Bitmap2_Length | Length of the second bitmap (if used) |
| Num Users | Maximum number of data users in the group |
| Bitmap Header Mode | The way to indicate the active users |
| Bitmap_Channel | Time frequency resources for the bitmap itself |
| AT_Index | The bitmap position assigned to the AT |
| | (if bitmap for data users is used), or |
| | the index assigned to the AT |
| Scrambling Code | The unique scrambling code assigned to |
| | this user |
| MCS Length | Length of each MCS field |
| SIZE Length | Length of each SIZE field |
| Interlace_Offset | Offset assigned to the AT indicative of its first |
| | transmission |

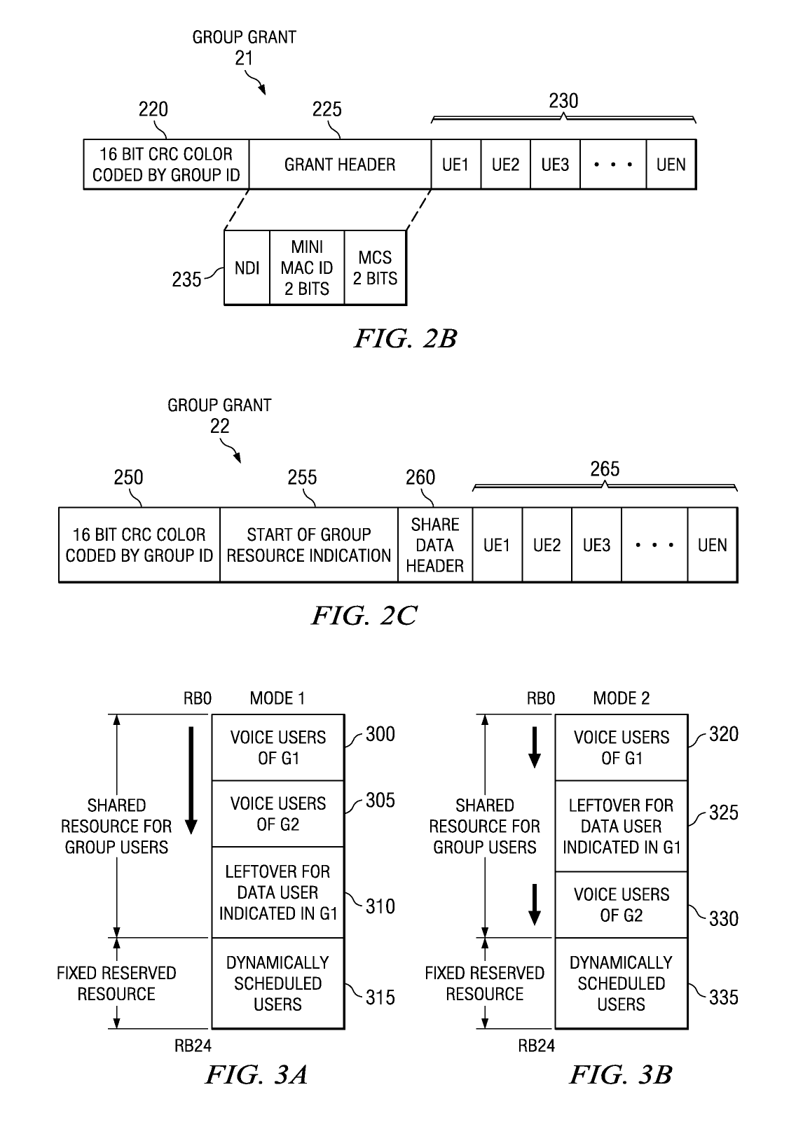

FIG. 2A is a block diagram illustrating group grant 20 configured according to one embodiment of the present invention. Besides the Group ID, group grant 20 includes color-coded 16-bit CRC 200, bitmaps 210 for UE1-UE‘N’, and 5-bit grant header 205. However, unlike 5-bit group resource address 101 (FIG. 1A), 5-bit grant header 205 is not used in the present embodiment to identify the start of the group resource, as depicted in FIG. 1. Instead, after the group has been set up by the upper layer Group Setup Message, group grant 20 is sent with 5-bit grant header 205 having bit fields of mini MAC ID 215 and MCS 216 for share data users. In this example, out of the 5 bits in this field, 3 bits are used for mini MAC ID 215 and 2 bits are used for MCS 216. Mini MAC ID 215 indicates the active share data user, while MCS field 216 indicates the corresponding MCS index. The mini MAC ID can be shared by multiple data users who will do blind detection at the receiver to determine if one is activated. This is preferable for certain groups whose starting point is either implicitly given, or defined by upper layer signaling.

For example, the first group usually starts from RB0 by default. Each mini MAC ID 215 can support one or multiple data users. When multiple data users share a single one of mini MAC ID 215, the scheduler has a constraint that it cannot consecutively schedule two users with the same mini MAC ID 215. MCS field 216 generally provides a number of bits to support multiple levels of MCS for the share data user. However, this field does not necessarily have to represent the absolute MCS levels. Instead, MCS field 216 may be various combinations of MCS and/or numbers of resource block allocation. Furthermore, any of the fields of bitmaps 210 for UE1-UE‘N’ can be used to indicate data users as well, as long as a fixed MCS level is pre-assigned for the data users.

FIG. 2B is a block diagram illustrating group grant 21 configured according to one embodiment of the present invention. Group grant 21 comprises similar structure as group grant 20 (FIG. 2A), i.e., 16-bit color-coded CRC 220, grant header 225, and bitmaps 230 for UE1-UE‘N’. In the present embodiment, however, grant header 225 may be replaced by single-bit new data indicator (NDI) 235, mini MAC ID 236, and MCS 237 for share data users. This embodiment, illustrated by group grant 21, may be used for certain groups where the resource starting point is either implicitly given or defined by upper layer signaling. For instance, the first group usually starts from RB0.

Each one of mini MAC ID 236 can support one or more data users. NDI 235 indicates the arrival of a new packet. Multiple data users can, therefore, share a single one of mini MAC ID 236, because NDI 235 will let the receiver know if the incoming packet is new or a retransmission. As with the previous embodiment, MCS field 237 supports multiple MCS levels for the share data user.

FIG. 2C is a block diagram illustrating extended group grant 22 configured according to one embodiment of the present invention. Extended group grant 22 comprises similar structure as group grant 20 (FIG. 2A) and 21 (FIG. 2B), i.e., 16-bit color-coded CRC 250 and bitmaps 265 for UE1-UE‘N’. However, instead of a single 5-bit grant header, extended group grant 22 is extended in length, including both group resource start indicator 255 and share data header 260. Thus, extended group grant 22 can include both the starting address of the group resources in group resource start indicator 255 and share data header 260, which provides the assignment information for the share data users, such as a mini MAC ID and/or NDI and/or MCS field and/or the like.

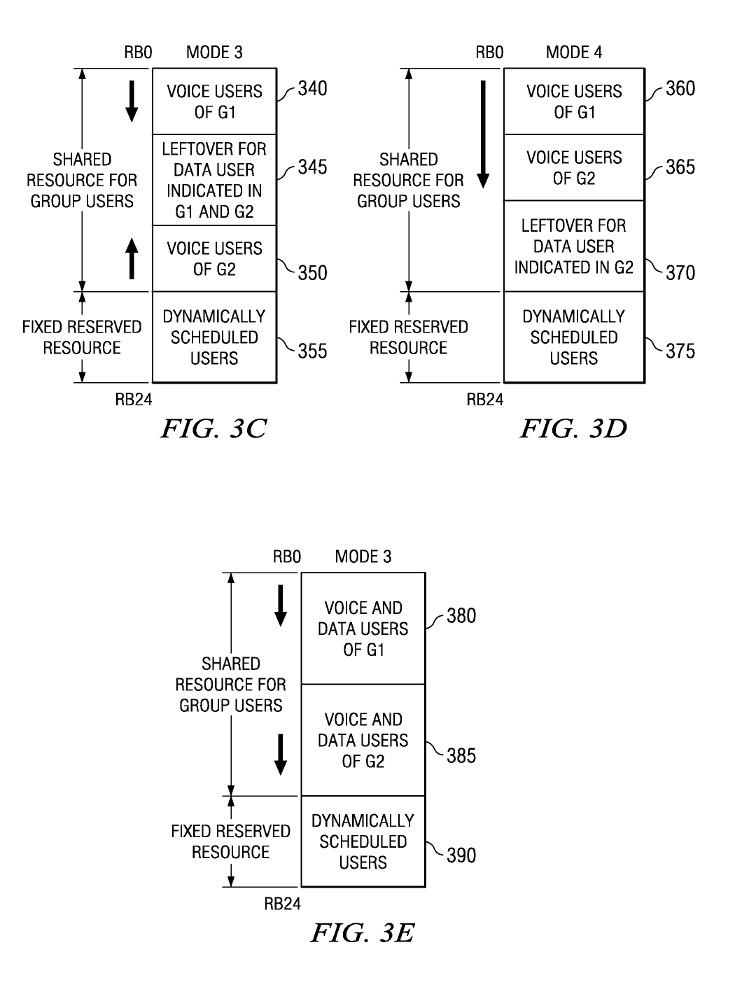

FIG. 3A is a block diagram illustrating resource allocation Mode 1 for multiplexing multiple voice and data users in a network configured according to one embodiment of the present invention. Resource allocation Mode 1 provides resource allocation of RB0-RB24 for a first group, group 1 (G1) 300, configured according to one embodiment of the present invention, and a second group, group 2 (G2) 305, configured according to existing group allocation methods, i.e., having only VoIP user bitmaps. The group users are notified of the size of the shared resource via upper layer signaling. Reserved resource 315, if any, is fixed such that the grant data users can be scheduled and have guaranteed HARQ retransmission resources. Resource blocks for VoIP users in G1 300 and G2 305 are stacked one after the other. While the group grant for G1 300 includes both share data users (e.g., 215-216 in FIG. 2A or 235-237 in FIG. 2B) and VoIP user information (bitmaps 210 in FIG. 2A or bitmaps 230 in FIG. 2B), the group grant for G2 305 is configured according to existing methods and, therefore, includes only VoIP user bitmaps.

As noted, the group grant for G1 300 indicates that share data users are present in G1 300. The group grant for G1 300, therefore, identifies leftover G1 resource 310 that the share data users can occupy after reading the group grant for G2 305. A scheduler at the base station decides (1) which data user is being served, (2) how much resource is assigned, and (3) which MCS is being used based on the channel quality, the quality of service (QoS) requirement, the buffer status, or the like. Each data user will look at the group grant for G1 300 first to see if it is being activated to share and, if so, will look at the corresponding MCS. The activated share data user will then proceed to look at the group grant for G2 305 which indicates the starting address of the resources assigned to G2 305. The activated share data user will then calculate the occupied blocks and locate the exact blocks it has been effectively assigned to. If no resources are left from VoIP users according to the bitmaps, the MCS index value is ignored.

The encoded packet size of the share data packet depends on the size of assigned resource and the MCS scheme used. Padding may be added if the number of information bits is less than the encoded packet size. The scheduler at the base station balances the power and MCS of the data user.

It should be noted that the mapping from the MCS bits to actual packet format may be adjusted by upper layer signaling.

It should further be noted that, in additional and/or alternative embodiments of implementations of the present invention, if there is only one group (e.g., G1 300, without G2 305), the share data users only needs access to the group grant for G1 and the maximum shared resource to determine its assigned blocks.

FIG. 3B is a block diagram illustrating resource allocation Mode 2 for multiplexing multiple voice and data users in a network configured according to one embodiment of the present invention. Resource allocation Mode 2 provides resource allocation of RB0-RB24 for a first group, group 1 (G1) 320, configured according to one embodiment of the present invention, a second group, group 2 (G2) 330, configured according to existing group allocation methods, i.e., having only VoIP user bitmaps, and reserved resource 335, which is fixed for dynamic allocation to fixed data users. However, while the resources allocated for G1 320 start from the beginning of the allocated resources, RB0, the resources allocated for G2 330 are positioned to end at the bottom of the shared resource of group users 330. This allocation configuration leaves leftover resource 325 located between G1 320 and G2 330. The share data users indicated in the group grant for G1 (215-216 in FIG. 2A or 235-237 in FIG. 2B), therefore, will be able to identify leftover G1 resource 325 after looking at the group grant for G2 330 for the start of allocated G2 330 resources.

It should be noted that a fixed number of resource blocks can be implicitly reserved with the group grants every time for dynamically granted data users, which will guaranteed the resource for the corresponding HARQ retransmissions. This mode is preferable because of these advantages. However, if there is only one group in an allocation scheme, e.g., G1 in resource allocation Mode 2, the maximum shared resource should be explicitly sent using an upper layer message so that the share data users can locate its assigned blocks.

FIG. 3C is a block diagram illustrating resource allocation Mode 3 for multiplexing multiple voice and data users in a network configured according to one embodiment of the present invention. Unlike the allocation schemes depicted in resource allocations Mode 1 (FIG. 3A) and Mode 2 (FIG. 3B), resource allocation Mode 3 is configured to handle multiple groups in which each group is configured according to one embodiment of the present invention which has both shared VoIP users and shared data users. Here, the size of shared resource for all group users, VoIP and data are provided via upper layer signaling. Reserved resource 355 is fixed so that the fixed, grant data users can be scheduled and have guaranteed HARQ retransmission resources. The allocation scheme for resource allocation Mode 3 defines the voice/VoIP users of G1 340 starting from the beginning of the allocated resources, RB0. The voice/VoIP users of G2 350, however, start from the end of the shared resource allocated to the group users (G1 340, G2 350, and leftover resource 345). This leaves leftover combined resource 345 lying between G1 340 and G2 350.

In one example of operation within resource allocation Mode 3, there are two share data users; one provided for in each of the group grant messages. In order to locate their respective resource allocation, each share data user looks at both group grants to determine the location of leftover combined resource 345. Once determined, each share data user will share leftover combined resource 345 in a predefined fashion, e.g., each taking half of the available resource, each taking a certain percentage based on the compared signal strength, each taking a certain percentage based on a compared priority, and the like.

It should be noted that, in the configuration of resource allocation Mode 3, no starting point field is needed for either group grant. Thus, the group grants for G1 340 and G2 350 may use 10 bits for the mini MAC ID and MCS fields instead of the typical 5 bits. In this configuration, there may be one share data user occupying 10 bits for mini MAC ID and MCS, e.g., 5 bits for mini MAC ID and 5 bits for MCS. Compared with extended group grant 22 (FIG. 2C), resource allocation Mode 3 allows more data users to share the mini MAC ID and smaller granularity of the MCS mapping.

FIG. 3D is a block diagram illustrating resource allocation Mode 4 for multiplexing multiple voice and data users in a network configured according to one embodiment of the present invention. Resource allocation Mode 4 allows a typical VoIP-only group, G1 360, to share resources with a group configured according to one embodiment of the present invention to multiplex both share voice/VoIP users and share data users over the same time-frequency resource, G2 365. In order to accomplish this variance, an extended grant header is used for G2 365. An extended grant header, as illustrated in FIG. 2C, indicates both resource start indicator 255 (FIG. 2C) and shared data header 260 (FIG. 2C).

The group grant for G1 360 has the original 5-bit grant header indicating the start of group resource. However, since the grant header for G2 365 becomes larger, the VoIP bitmaps of G2 365 are correspondingly reduced due to the fixed group grant size. Similarly to the previous resource allocation schemes, the size of the shared resources for the group users (i.e., voice/VoIP users of G1 360, voice/VoIP users of G2 365, and leftover G2 resource 370) are notified via upper layer signaling. The reserved resource 375, if any, is fixed so that the grant data users can be scheduled and have guaranteed HARQ retransmission resource. The share data users only need look at the last group grant to locate the leftover G2 resource 370 for their transmissions.

FIG. 3E is a block diagram illustrating resource allocation Mode 5 for multiplexing multiple voice and data users over the same time-frequency resource in a network configured according to one embodiment of the present invention. Resource allocation Mode 5 is set up using a group grant with a share data header that includes a mini MAC ID, an MCS, and an NDI. The starting and ending RB location of each group (G1 380 and G2 385) are pre-defined in a Group Setup Message, and only change slowly, if ever, by using upper layer signaling. Each share data user will, therefore, look at its own group grant and occupy only the leftover resource within its own group grant resource allocation. As with the preceding example embodiments, the size of the shared resources for all group users is provided via upper layer signaling. Reserved resource 390 is fixed so that the grant data users can be scheduled and have guaranteed HARQ retransmission resource.

It should be noted that the example implementation described with respect to FIG. 3F may also be implemented using a group grant that does not include an NDI.

It should further be noted that in any of the preceding embodiments, resource allocation Modes 1-5 (FIGS. 3A-3E), there may be no resources reserved for the grant data users. Therefore, the resource allocations would not have reserved resources 315, 335, 355, 375, and 390, respectively.

In resource allocation Modes 1 through 5 (FIGS. 3A-3E), the mini MAC ID may be shared by multiple data users who will do blind detection at the receiver to determine if one is activated. When a group grant format is configured to include an NDI bit, such as NDI 235 in group grant 21 (FIG. 2B), the activated share data user will know exactly if the received subpacket is a new packet or a retransmission of a previous subpacket, so can determine when the data buffer can be flushed. In additional and/or alternative embodiments when the group grant format is configured without an NDI bit, such as in group grant 20 (FIG. 2A), one constraint is applied to the base station scheduler that there should be no consecutive assignments to the share data users with the same mini MAC ID. In this manner, the activated data user is able to determine if the received subpacket is a new packet or a retransmission of a previous subpacket, and flushes its data buffer accordingly.

For the retransmission of the data packets, there are various methods that may be used. One method is to simply delay the subpacket retransmission until the resource becomes available. Another method is to use adaptive retransmission, i.e., partitioning the subpacket to fit in the size of the left over resource for retransmissions. A more aggressive method is to allow the base station to reserve the resource in the group for any subpacket retransmission until this subpacket is acknowledged or the maximum number of retransmissions is reached. While this more aggressive method provides more definite resource availability, it may slightly affect the VoIP user transmissions. Another method for retransmitting data packets is simply to use any available resource within the reserved resource (e.g., reserved resource 315 (FIG. 3A), reserved resource 335 (FIG. 3B), reserved resource 355 (FIG. 3C), and so on) with a data grant for the subpacket retransmission. This method for using the available reserved resource may also guarantee any further subpacket retransmissions by using data grant.

To further alleviate the constraint over retransmission resources, power control may be used to target an earlier termination than set in the default so that the number of retransmissions can be reduced.

It should be noted that while the various alternative embodiments of the present invention described herein have been described in terms of VoIP and data users, additional and/or alternative embodiments of the present invention may be further generalized to two prioritized user types. For example, the first user type is classified as higher priority with, for instance, latency sensitive services, loss sensitive services, or the like, while the second type of users are of lower priority with, for instance, latency insensitive services, loss insensitive services, or the like. Regardless of whether the two user types are voice/VoIP and data or simply higher priority vs. lower priority, the methods and configurations described above still equally apply.

It should further be noted and obvious to those skilled in the art that other ways of setting the values of bits in group grants are possible without deviating from the spirits of the present invention.

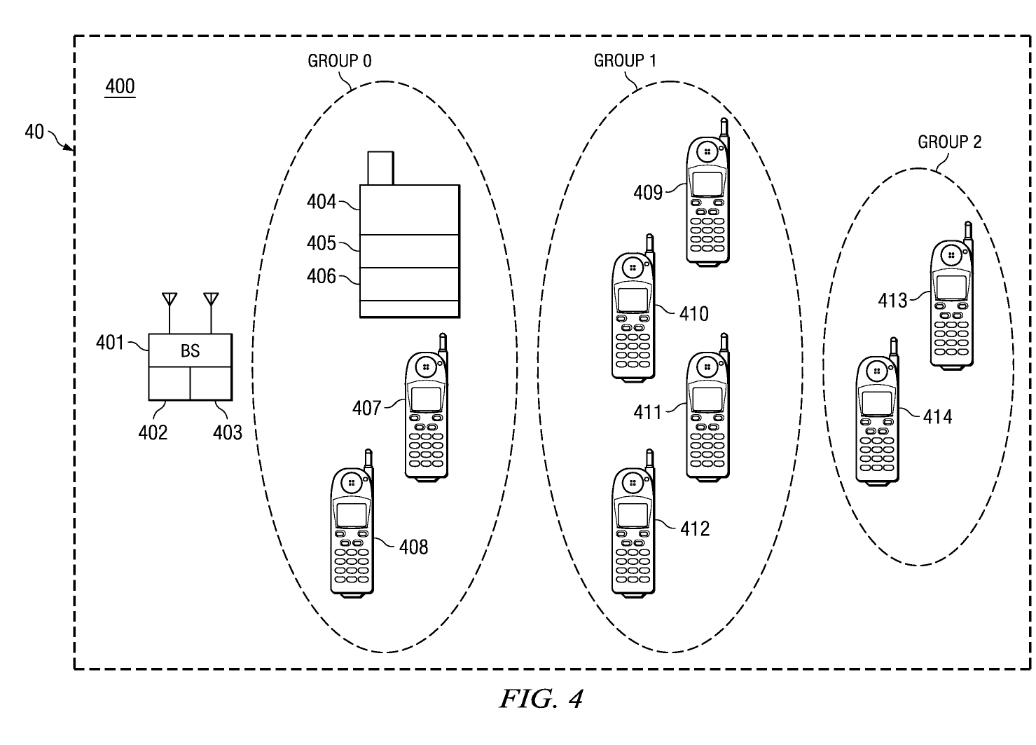

FIG. 4 is a block diagram illustrating sector 400 of network 40 configured according to one embodiment of the present invention. Base station (BS) 401 comprises, among other things, processor 402 and memory 403 for storing various applications for managing and controlling the operation of sector 400. BS 401 services each of the UE within sector 400, mobile units 404 and 407-414. Mobile unit 404 is an expanded view showing processor 405 and memory 406, which stores the various tables, applications, and other data that provides the functionality of mobile unit 404 including the operation of the unit itself and operation within network 40. Mobile units 407-414 each include at least a processor and memory (not shown) as depicted in mobile unit 404.

In managing sector 400, BS 401 divides mobile units 404 and 407-414 into groups through a Group Setup Message. The Group Setup Message includes assignment of a GroupID, and MAC ID, and associates the unique identifier for each of mobile units 404 and 407-414 to its specific GroupID. In the operation illustrated in FIG. 4, BS 401 has assigned mobile units 404, 407, and 408 to Group 0, mobile units 409-412 to Group 1, and mobile units 413-414 to Group 2. BS 401 thereafter allocates resources to Groups 0-2, in which two or more of the groups may share the same time-frequency resources. Additionally, within each of Groups 0-2, some of the mobile units may be share voice users while others are share data users. Because network 40 is configured according to one embodiment of the present invention, both the share voice and data users may share the same assigned time-frequency resources. BS 401 allocates resources to Groups 0-2 using group grants, which may be configured according to any one or more of the embodiments illustrated in FIGS. 2A-2C. The resulting allocation algorithms will, therefore, comprise any one of those illustrated in FIGS. 3A-3E, depending on the particular mode selected by the operator of network 40.

Although the messages are sent by the base station and received by the mobile station in various examples illustrated in the previous sections, the present invention contemplates to use these novel methods on the messages sent by any one communications terminal and received by any other communications terminal.

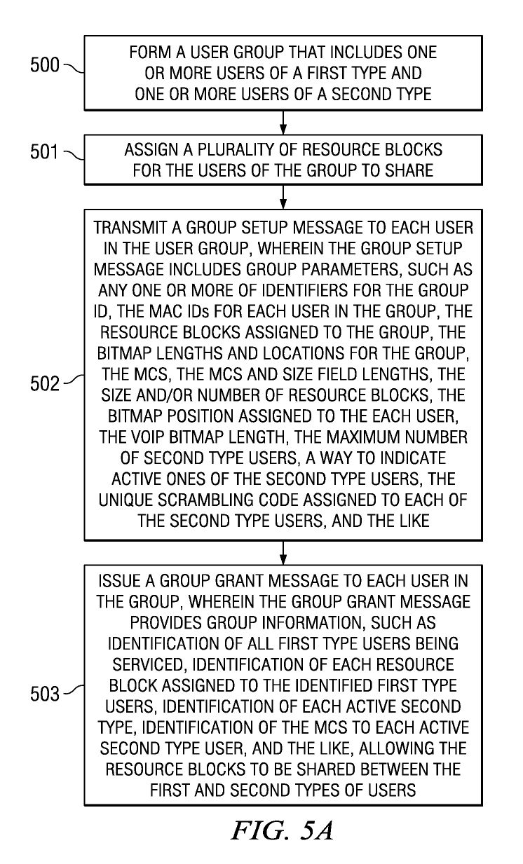

FIG. 5A is a flowchart illustrating example steps executed to implement one embodiment of the present invention. In step 500, a user group is formed that includes one or more users of a first type and one or more users of a second type. A plurality of resource blocks are assigned, in step 501, for the users of the group to share. A group setup message is transmitted, in step 502, to each user in the user group, wherein the group setup message includes group parameters, such as any one or more of identifiers for the group ID, the MAC IDs for each user in the group, the resource blocks assigned to the group, the bitmap lengths and locations for the group, the MCS, the MCS and SIZE field lengths, the size and/or number of resource blocks, the bitmap position assigned to the each user, the VoIP bitmap length, the maximum number of second type users, a way to indicate active ones of the second type users, the unique scrambling code assigned to each of the second type users, and the like. In step 503, a group grant message is issued to each user in the group, wherein the group grant message provides group information, such as identification of all first type users being serviced, identification of each resource block assigned to the identified first type users, identification of each active second type, identification of the MCS to each active second type user, and the like, allowing the resource blocks to be shared between the first and second types of users.

FIG. 5B is a flowchart illustrating example steps executed to implement another embodiment of the present invention. In step 504, a group setup message is received at the data user identifying at least a group of users sharing a set of communication resources, the set of shared communication resources, and a unique scrambling code for the data user. An active user signal is received, in step 505, identifying the data user as an active share data user. A group grant message is received at the active share data user, in step 506, in which the group grant message, using bitmap signaling, identifies a first boundary of a subset of the set of communication resources allocated to the active share data user and a modulation and coding scheme (MCS) for the active share data user. In step 507, the active share data user uses the subset of the set of communication resources to perform data communication.

The various illustrative logical blocks, modules, and circuits described in connection with the embodiment disclosed herein may be implemented or performed with, but not limited to, a general purpose processor, a digital signal processor (DSP), an application specific integrated circuit (ASIC), a memory device such as RAM, ROM, EPROM, or EEPROM, a field programmable gate array (FPGA) or other programmable logic device, discrete gate or transistor logic, discrete hardware components, and any combination thereof designed to perform the functions described herein.

The program or code segments making up the various embodiments of the present invention may be stored in a computer readable medium or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, and the like. The computer data signal may include any signal that can propagate over a transmission medium such as electronic network channels, optical fibers, air, electromagnetic, RF links, and the like. The code segments may be downloaded via computer networks such as the Internet, Intranet, and the like.

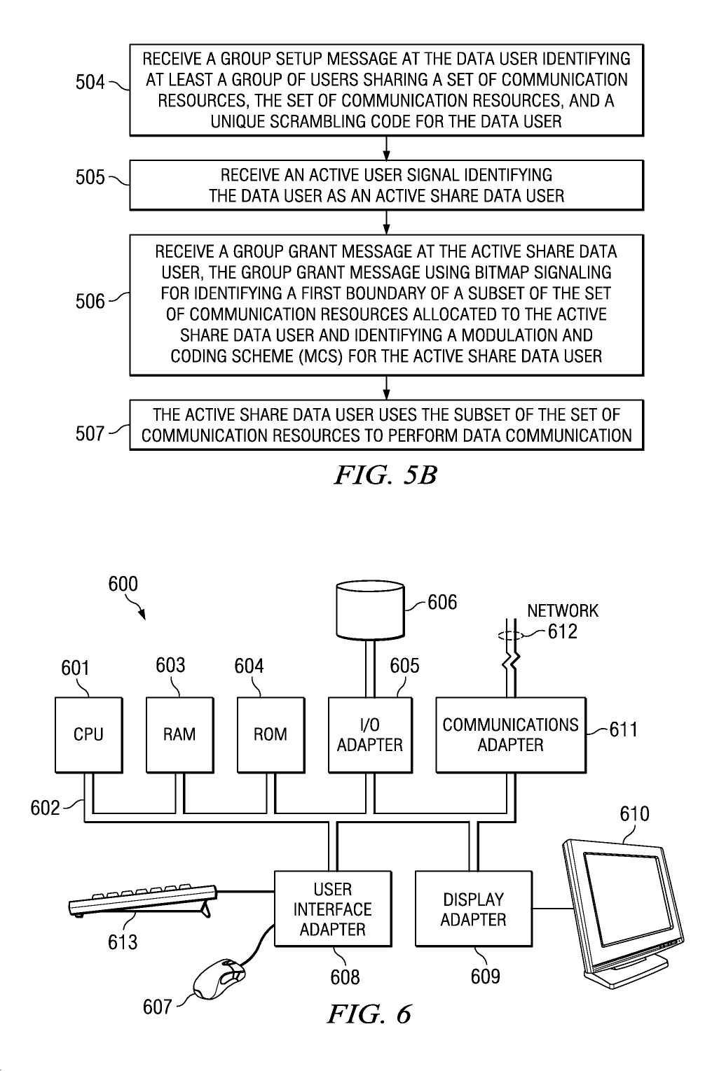

FIG. 6 illustrates computer system 600 adapted to use embodiments of the present invention, e.g. storing and/or executing software associated with the embodiments. Central processing unit (CPU) 601 is coupled to system bus 602. The CPU 601 may be any general purpose CPU. However, embodiments of the present invention are not restricted by the architecture of CPU 601 as long as CPU 601 supports the inventive operations as described herein. Bus 602 is coupled to random access memory (RAM) 603, which may be SRAM, DRAM, or SDRAM. ROM 604 is also coupled to bus 602, which may be PROM, EPROM, or EEPROM. RAM 603 and ROM 604 hold user and system data and programs as is well known in the art.

Bus 602 is also coupled to input/output (I/O) controller card 605, communications adapter card 611, user interface card 608, and display card 609. The I/O adapter card 605 connects storage devices 606, such as one or more of a hard drive, a CD drive, a floppy disk drive, a tape drive, to computer system 600. The I/O adapter 605 is also connected to a printer (not shown), which would allow the system to print paper copies of information such as documents, photographs, articles, and the like. Note that the printer may be a printer (e.g., dot matrix, laser, and the like), a fax machine, scanner, or a copier machine.

Obviously, numerous variations and modifications can be made without departing from the spirit of the present invention. Therefore, it should be clearly understood that the form of the present invention described above and shown in the figures of the accompanying drawing is illustrative only and is not intended to limit the scope of the present invention.

What is claimed is:

1. A method for assigning communication resources to share between different types of users, said method comprising:
forming a user group, said user group comprising:
one or more first users of a first type; and
one or more second users of a second type;
assigning a plurality of resource blocks to said user group;
transmitting a group setup message to each user in said user group, wherein said group setup message includes group parameters and identification of said plurality of resource blocks;
issuing a group grant message to each user in said user group, wherein said group grant message provides group information allowing said plurality of resource blocks to be shared between said one or more first users of said first type and said one or more users of said second type.

2. The method of claim 1 wherein said group information is transmitted using bitmap signaling.

3. The method of claim 1 wherein said group information comprises one or more of:
identification of all users of said one or more first users of said first type being serviced;
identification of each resource block of said assigned plurality of resource blocks assigned to said identified one or more first users of said first type;
identification of each active user of said one or more second users of said second type; and
identification to said each active user a modulating-coding scheme being used in the communication resources.

4. The method of claim 1 wherein active ones of said one or more second users of said second type are identified via a uniquely assigned media access control identifier (MAC ID) transmitted with said group setup message.

5. The method of claim 1 wherein said group setup message comprises one or more of:
a group identifier (group ID);
a MAC ID for said each user in said user group;
identification of said plurality of resource blocks assigned to said user group;
bitmap lengths and locations for said user group;
identification of a modulation and coding scheme (MCS) field length;
identification of a SIZE field length;
identification of a size of resource blocks;
identification of a number of resource blocks assigned to said user group;
identification of a bitmap position assigned to said each user of said user group;
identification of a VoIP bitmap length;
identification of a maximum number of second type users;
identification a way to indicate active ones of all users of said second type in said user group; and
identification of a unique scrambling code assigned to ones of said all users of said second type in said user group.

6. The method of claim 5 wherein more than one user is associated with each said MAC ID.

7. The method of claim 1 wherein said first type comprise services having a higher priority and said second comprise services having a lower priority.

8. The method of claim 1 wherein said first type comprises VoIP users and said second type comprises data users.

9. The method of claim 1 further comprising:
forming a second user group, said second user group comprising:
one or more additional first users of said first type; and
zero or more additional second users of said second type;
assigning said plurality of resource blocks to said second user group;
transmitting a second group setup message with second group parameters and identification of said plurality of resource blocks to each user in said second user group;
issuing a second group grant message to each user in said second user group, wherein said second group grant message provides second group information allowing said plurality of resources to be shared between said first user group and said second user group.

10. The method of claim 9 wherein there are zero of said zero or more additional second users of said second type.

11. The method of claim 10 wherein active ones of said one or more second users of said second type are identified via a uniquely assigned media access control identifier (MAC ID) transmitted with said group setup message.

12. The method of claim 10 wherein a starting address of said plurality of resource blocks reserved for said user group is one of:
known to said each user in said user group;
one of said plurality of resource blocks labeled with a lowest address;
signaled explicitly to said each user in said user group.

13. The method of claim 10 wherein said group information is transmitted using bitmap signaling, wherein said bitmap signaling indicates one boundary of ones of said plurality of resource blocks assigned to said active ones of said one or more second users of said second type, and wherein one of:
another boundary is explicitly signaled in said group setup message to said active ones of said one or more second users of said second type;
a size of said ones of said plurality of resource blocks assigned to said active ones of said one or more second users of said second type is indicated by explicit signaling;
said another boundary of said ones of said plurality of resource blocks assigned to said active ones of said one or more second users of said second type is indicated by explicit signaling outside of said group setup message; and
said another boundary of said ones of said plurality of resource blocks assigned to said active ones of said one or more second users of said second type is indicated by a second starting address of a group resource indicator from said second group grant message for said second user group.

14. The method of claim 9 wherein there is at least one of said zero or more additional second users of said second type.

15. The method of claim 14 wherein said second group grant message indicates active ones of said at least one of said zero or more additional second users of said second type.

16. The method of claim 14 wherein an indication of active ones of said at least one of said zero or more additional second users of said second type is with a uniquely assign MAC ID in said second group setup message.

17. The method of claim 14 wherein said group information and said second group information are transmitted using bitmap signaling, said bitmap signaling indicating one boundary of ones of said plurality of resource blocks assigned to active ones of all users of said second type for each of said user group and said second user group, and wherein one of:
another boundary is explicitly signaled in said group setup message and said second group setup message to said active ones of all users of said second type;
a size of said ones of said plurality of resource blocks assigned to said active ones of all users of said second type is indicated by explicit signaling; and
said another boundary of said ones of said plurality of resource blocks assigned to said active ones of all users of said second type is indicated by explicit signaling outside of said group setup message.

18. The method of claim 14 wherein said bitmap signaling in said group grant message indicates one boundary of said ones of said plurality of resource blocks assigned to active ones of all users of said second type in said user group and another boundary of said ones of said plurality of resource blocks assigned to active ones of all users of said second type in said second user group is indicated by a start address of a group resource indicator from said second group grant message.

19. The method of claim 1 further comprising:
indicating via a new packet indicator and user blind detection, which said one or more second users of said second type is scheduled to receive a new packet.

20. The method of claim 19 wherein a starting address of said new packet indicator is used to inform said one or more second users of said second type if said new packet is arriving; and
providing signaling in an MCS field to indicate a modulation and coding scheme to said new packet; and
scrambling transmitted data within each data pipe using a user-specified scrambling code for said one of said one or more second users of said second type scheduled to receive said new packet, wherein said one or more second users of said second type blindly attempt to unscramble said scrambled transmitted data, wherein only one of second users of said second type scheduled to receive said new packet will succeed in unscrambling said new packet.

21. The method of claim 20 wherein said starting address of said new packet is indicated when a MAC ID indicated in said group grant message is different from another MAC ID indicated by a most recent last group grant message.

22. The method of claim 20 wherein said group information is transmitted using bitmap signaling, in which one bit of said bitmap signaling is used to indicate said starting address of said new packet.

23. The method of claim 20 wherein said starting address of said new packet is indicated by explicit signaling.

24. A method for a data user to obtain communication resources in a wireless communication network, said method comprising:
receiving a group setup message at said data user identifying:
a group of users sharing a set of communication resources;
said set of communication resources; and
a unique scrambling code for said data user;
receiving an active user signal identifying said data user as an active share data user;
receiving a group grant message at said active share data user, said group grant message using bitmap signaling for:
identifying a first boundary of a subset of said set of communication resources allocated to said active share data user; and
identifying a modulation and coding scheme (MCS) for said active share data user; and
using said subset of said set of communication resources by said active share data user to perform data communication.

25. The method of claim 24 wherein said active user signal is received from one of:
said group grant message; and
explicit signaling.

26. The method of claim 24 wherein a starting address of said set of communication resources is one of:
known to said active share data user;
one of said set of communication resources having a lowest address; and
signaled explicitly to said active share data user.

27. The method of claim 24 further comprising one of:
receiving an explicit boundary signal identifying another boundary of said subset of said set of communication resources;
receiving an explicit size signal identifying a size of each resource blocks comprising said set of communication resources; and
deducing said another boundary of said subset of said set of communication resources from a second starting address of a group resource indicator from a second group grant message for a second user group.

28. The method of claim 24 further comprising:
receiving a new packet indicator at said active share data user identifying arrival of a scrambled new packet;
receiving said scrambled new packet at said active share data user;
attempting, by said active share data user, to descramble said scrambled new packet using said unique scrambling code identified by said group grant message; and
responsive to success of said attempting, processing said new packet at said active share data user.

29. The method of claim 24 wherein said group setup message comprises one or more of:
a group identifier (group ID);
a MAC ID for said each user in said group of users;
identification of an MCS field length;
identification of a SIZE field length;
identification of a size of resource blocks;
identification of a number of resource blocks in said set of communication resources assigned to said group of users;
identification of a starting address for said set of communication resources;
identification of a bitmap position assigned to said each user of said group of users;
identification of a VoIP bitmap length;
identification of a maximum number of data users; and
identification a way to indicate active ones of all data users in said group of users.

30. A computer program product having a computer readable medium with computer program logic recorded thereon, said computer program product comprising:
code for forming a user group, said user group comprising:
one or more first users of a first type; and
one or more second users of a second type;
code for assigning a plurality of resource blocks to said user group;
code for transmitting a group setup message to each user in said user group, wherein said group setup message includes group parameters and identification of said plurality of resource blocks;
code for issuing a group grant message to each user in said user group, wherein said group grant message provides group information allowing said plurality of resources to be shared between said one or more first users of said first type.

31. The computer program product of claim 30 further comprising:
code for generating said group information, wherein said code for generating includes code for adding:
identification of all users of said one or more first users of said first type being serviced;
identification of each resource block of said assigned plurality of resource blocks assigned to said identified one or more first users of said first type;
identification of each active user of said one or more second users of said second type; and
identification to said each active user a modulating-coding scheme being used in the communication resources.

32. The computer program product of claim 30 further comprising:
code for forming a second user group, said second user group comprising:
one or more additional first users of said first type; and
zero or more additional second users of said second type;
code for assigning said plurality of resource blocks to said second user group;
code for transmitting a second group setup message with second group parameters and identification of said plurality of resource blocks to each user in said second user group;
code for issuing a second group grant message to each user in said second user group, wherein said second group grant message provides second group information allowing said plurality of resources to be shared between said first user group and said second user group.

33. The computer program product of claim 32 wherein there are zero of said zero or more additional second users of said second type and wherein said group information is transmitted using bitmap signaling, wherein said bitmap signaling indicates one boundary of ones of said plurality of resource blocks assigned to said active ones of said one or more second users of said second type, and wherein one of:
another boundary is explicitly signaled in said group setup message to said active ones of said one or more second users of said second type;
a size of said ones of said plurality of resource blocks assigned to said active ones of said one or more second users of said second type is indicated by explicit signaling;
said another boundary of said ones of said plurality of resource blocks assigned to said active ones of said one or more second users of said second type is indicated by explicit signaling outside of said group setup message; and
said another boundary of said ones of said plurality of resource blocks assigned to said active ones of said one or more second users of said second type is indicated by a second starting address of a group resource indicator from said second group grant message for said second user group.

34. The method of claim 33 wherein there is at least one of said zero or more additional second users of said second type and wherein said group information and said second group information are transmitted using bitmap signaling, said bitmap signaling indicating one boundary of ones of said plurality of resource blocks assigned to active ones of all users of said second type for each of said user group and said second user group, and wherein one of:
another boundary is explicitly signaled in said group setup message and said second group setup message to said active ones of all users of said second type;
a size of said ones of said plurality of resource blocks assigned to said active ones of all users of said second type is indicated by explicit signaling; and
said another boundary of said ones of said plurality of resource blocks assigned to said active ones of all users of said second type is indicated by explicit signaling outside of said group setup message.

35. The method of claim 33 wherein there is at least one of said zero or more additional second users of said second type and wherein said bitmap signaling in said group grant message indicates one boundary of said ones of said plurality of resource blocks assigned to active ones of all users of said second type in said user group and another boundary of said ones of said plurality of resource blocks assigned to active ones of all users of said second type in said second user group is indicated by a start address of a group resource indicator from said second group grant message.

36. The method of claim 30 further comprising:
code for transmitting a starting address of a new packet indicator, wherein said starting address is used to inform one of said one or more second users of said second type if said new packet is arriving;
code for generating signaling in an MCS field to indicate a modulation and coding scheme for said new packet; and
code for scrambling transmitted data within each data pipe using a user-specified scrambling code for said one of said one or more second users of said second type scheduled to receive said new packet, wherein said one or more second users of said second type blindly attempt to unscramble said scrambled transmitted data, wherein only one of second users of said second type scheduled to receive said new packet will succeed in unscrambling said new packet.
